(19) United States
(12) Patent Application Publication
(10) Pub. No.: US 2008/0113160 A1
(43) Pub. Date: May 15, 2008

(54) Method And Apparatus For Localized Bonding

(75) Inventors: Andres Fernandez, San Francisco, CA (US); Bryan P. Staker, Pleasanton, CA (US); Alexander P. Kindwall, San Francisco, CA (US); Windsor E. Owens, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Glimmerglass Networks, Inc., Hayward, CA (US)

(21) Appl. No.: 11/559,831

(22) Filed: Nov. 14, 2006

(51) Int. Cl. B32B 7/14; B32B 37/02; B32B 37/14

(52) U.S. Cl. 428/173; 428/172; 156/291

(57) ABSTRACT

One or more cavities are formed in the bonding surfaces of one, all, or some of the elements to be bonded. These cavities serve as receptacles for the bonding material and are where the bonds are localized. The cavities are of sufficient size and shape so that their volume is greater than the volume of bonding material forming the bond. This ensures that when the elements are brought into contact with one another to mate, the bonding material, which can flow prior to solidifying into a bond, will flow into the cavities and will not impede the separation of the parts. This allows the parts to be mated with nominally zero separation. Once solidified, the bonding material forms a localized bond inside each cavity. Different cavity shapes, such as, rectangular, circular, or any other shape that can be injected or filled with adhesive material may be used.

### BACKGROUND OF THE INVENTION

The present invention relates to bonding of two or more parts, and more particularly to bonding of two or more parts while maintaining a very small, nearly zero, gap between the surfaces of the bonded parts.

For many applications, achieving a nominally zero-gap between the bonded parts is critical for the proper functioning of the combined structure. For example, the gap defining the distance between the part forming an actuation element of a micro-electro mechanical systems (MEMS) device, and the part forming the element undergoing actuation is critical to the proper operation of the device.

FIG. 1 is an exemplary view of an electrostatically driven micro-mirror 10, as known in the prior art. Micro-mirror 10 is shown as including a micro-machined mirror 12, which can pivot about hinges, and electrostatic actuation electrodes 14 positioned below micro-machined mirror 12 and located on substrate 16. The micro-mirror and substrate are often fabricated separately and then bonded together to form the final device. Voltage applied to the electrodes causes the mirror to tilt. Because the force exerted on the mirror by the electrodes is a sensitive function of the separation between the mirror and the electrodes, it is important to hold the separation between the above-mentioned parts to a tight tolerance. Hence it is desirable to maintain the distance between the two bonding surfaces as small as possible, e.g., to a nominally zero-gap.

Standard bonding techniques that can result in nominally zero-gap separation include, for example, fusion bonding, eutectic bonding, and anodic bonding. Fusion bonding is typically done at temperatures approaching 700° C. while eutectic bonding can be done at 300° C. Anodic bonding is limited to bonding semiconductor materials to glass. If the maximum temperature to which the parts can be exposed is less than 300° C., as for example if the parts consist of materials that degrade at temperatures above 300° C., or the materials are not compatible with anodic bonding, then an alternate technique must be used.

The use of adhesives or solder to bond parts together can be done at much lower temperatures than fusion or eutectic bonding. Adhesives or solders generally require elevated temperatures, but depending on the choice of materials can be done at temperatures below 100° C. The difficulty with adhesives or solders is achieving a controllable separation between the parts being bonded. If the bond material is applied between the two parts to be bonded, a nearly zero-gap separation is not possible because a finite amount of material is needed to maintain sufficient bond strength. Alternatively, if bond material is applied externally after the parts are mated (for example at the edges of the parts) the overall bond strength may not be sufficiently robust.

What is needed is a means of bonding parts together using adhesives or solder while achieving a nearly zero-gap separation between the parts. This would allow, for example, the manufacturing of the MEMS device, such as that shown in FIG. 1 to be achieved in a highly controllable manner and in such a way that would maximize performance uniformity.

### BRIEF SUMMARY OF THE INVENTION

In accordance with the present invention, the distance between the surfaces of one or more bonded parts is substantially reduced by forming one or more cavities in the bonding surfaces of one, all, or some of the mating elements to be bonded. These cavities serve as receptacles for the bonding material and are where the bonds are localized. The cavities are of sufficient size and shape so that their volume is greater than the volume of bonding material dispensed therein. This ensures that when the elements are brought into contact with one another to mate, the bonding material, which can flow prior to solidifying into a bond, will flow within the cavities and will not impede the separation of the parts. This allows the parts to be mated with nominally zero separation. Once solidified, the bonding material forms a localized bond inside each cavity.

A variety of cavity shapes, such as rectangular, circular, or any other shape that can be injected or filled with bonding material may be used. In some embodiments, the bonding surfaces may be parallel or perpendicular to the mating surfaces. In yet other embodiments, one or more protrusions may be included inside the cavities so as to increase the surface area of the bonds. Features may be incorporated in the cavities to accommodate an overflow of bonding material.

It is understood that the bonding material may be any type of adhesive or solder suitable for the bonded elements. Such materials can easily be inserted into the bonding cavities before the bonds are hardened. Furthermore, a variety of processes can be used to form the bonding cavities such as etching, electroplating, or injection molding in accordance with the present invention. For example, if one of the parts is a thin silicon wafer or chip, the cavities can be formed by a deep-reactive-ion-etching process. A photoresist or silicon dioxide layer can serve as a mask for the etching process. The cavities can be formed prior to or after the active devices are fabricated, or they can be integrated into the device fabrication process.

After the cavities have been formed and the parts are ready for bonding, a controlled volume of bonding material is introduced into the cavities. A needle-dispense process or screen-print process can be used. The dispensing process must satisfy two important conditions: 1) the volume of the bonding material must be less than the volume of the cavity into which it is injected, and 2) the bonding material must protrude from one of the mating surfaces sufficient to make contact with the mating part when they are pressed together.

After introduction of the bonding material into the cavities, pressure is applied between the parts until the mating surfaces make contact. The bond material is allowed to cure either at room temperature or at elevated temperatures, depending on the bonding material requirements. After curing, the combined structure is either completed or is ready for another part to be bonded. The invention is explained in greater detail in connection with the drawings.

### BRIEF DESCRIPTION OF THE DRAWINGS

FIG. 1 is an perspective view of an electrostatically driven micro-mirror, as known in the prior art.

FIG. 2A shows a pair of elements that are to be bonded, in accordance with one embodiment of the present invention.

FIG. 2B shows a cavity formed in one of the elements of FIG. 2A, in accordance with one embodiment of the present invention.

FIG. 2C shows a bonding material dispensed in the cavity of FIG. 2B, in accordance with one embodiment of the present invention.

FIG. 2D is a cross-sectional view of the elements shown in FIG. 2C after they are brought into contact with one another, in accordance with one embodiment of the present invention.

FIG. 2E is a top view of the structure with cavity shown in FIG. 2C, in accordance with one embodiment of the present invention.

FIG. 3A is a cross-sectional view of pair of elements bonded via a multitude of cavities, in accordance with another embodiment the present invention.

FIG. 3B is a top view of an element having rows and columns of cavities formed therein in accordance with another embodiment the present invention.

FIG. 3C shows electrical connections between active devices formed on elements that are bonded together, in accordance with one embodiment of the present invention.

FIG. 4A is a cross-sectional view of three elements stacked and bonded, in accordance with another embodiment the present invention.

FIG. 4B is a cross-sectional view of a pair of elements bonded via a multitude of cavities, in accordance with another embodiment the present invention.

FIG. 4C is a cross-sectional view of a pair of elements bonded via a multitude of cavities, in accordance with another embodiment the present invention.

FIGS. 5A and 5B are cross-sectional and top views of a symmetric cavity formed in an element and for use in bonding in accordance with another embodiment of the present invention.

FIGS. 6A and 6B are cross-sectional and top views of a cavity and a wicking barrier, formed in an element and in accordance with another embodiment of the present invention.

FIG. 7 is an enlarged view of the cavity and wicking barrier of FIG. 6A, in accordance with another embodiment of the present invention.

FIG. 8A is a cross sectional view of a pair of elements bonded to hermetically seal one or more devices formed in the interior region of one of the elements, in accordance with another embodiment of the present invention.

FIG. 8B is a top view of the element of FIG. 8A that includes the active devices, in accordance with another embodiment of the present invention.

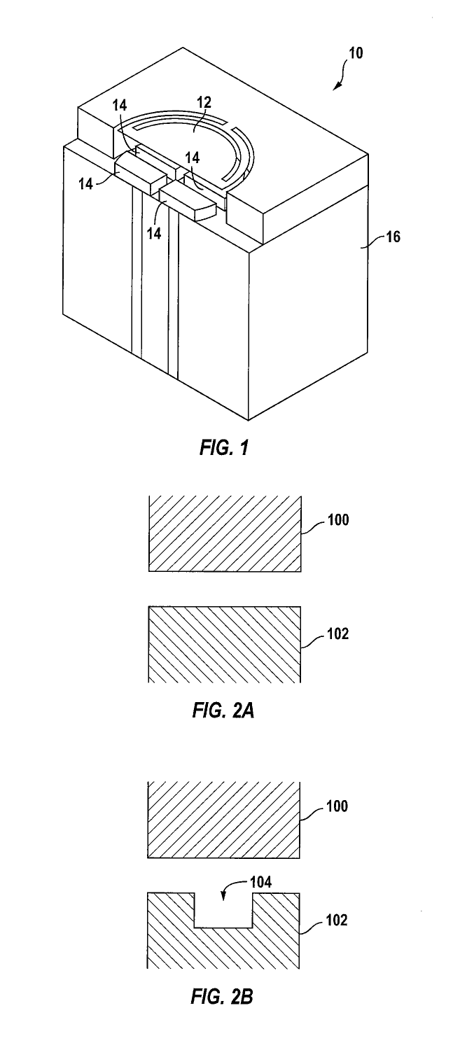

### DETAILED DESCRIPTION OF THE INVENTION

In accordance with the present invention, the distance between the surfaces of one or more parts bonded together is substantially reduced to a point of substantially zero-gap. Although, the following description is provided with reference to MEMS devices, it is understood that the present invention is equally applicable to other microstructures such as, semiconductor chips, micro-fluidic devices, and other types of hybrid structures in which there is substantive gain or advantage in having the parts bonded with a nearly zero (e.g., a few atomic layers) separation between the mating surfaces and in having the bonds localized. For example, this technique can be applied to the bonding of a multitude of integrated circuit chips to form a hybrid chip stack. It is also understood that the bonding surfaces may or may not be co-planar. Accordingly, the present invention applies as long as the bonding surfaces have matching shapes and can be brought to proximity of one another.

To achieve near-zero gap bonding, one or more cavities are formed in the bonding surfaces of one, all, or some of the elements to be bonded. These cavities serve as receptacles for the bonding material and are where the bonds are localized, as described further below. The cavities are of sufficient size and appropriate shape so that their volume is greater than the volume of bonding material forming the bond. This ensures that when the elements are brought into contact with one another to mate, the bonding material, which can flow prior to solidifying into a bond, will flow into the cavities and will not impede the separation of the parts. This allows the parts to be mated with nominally zero separation. Once solidified, the bonding material forms a localized bond between the opposing surface and the walls inside each cavity.

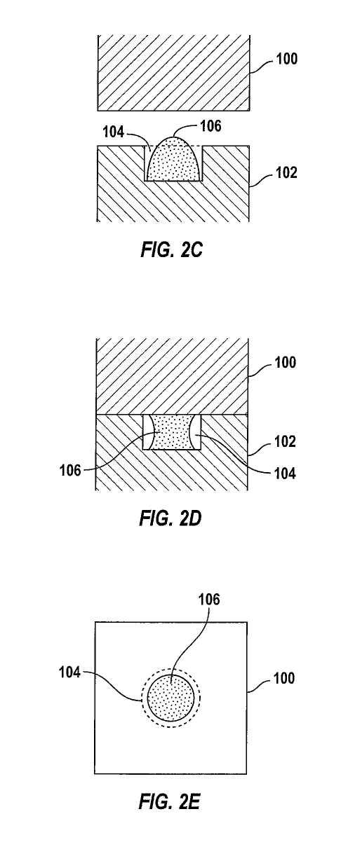

FIG. 2A shows a pair of elements 100 and 102 that are to be bonded in accordance with one embodiment of the present invention. To bond elements 100 and 102, first a cavity 104 is formed in one of the elements, e.g. element 102, as shown in FIG. 2B. Thereafter, a bonding material 106 is dispensed in cavity 104, as shown in FIG. 2C. Cavity 104 has a volume that is greater than the volume of bonding material 106 dispensed therein. Next, elements 100 and 102 are brought into contact with one another, as shown in FIG. 2D. The contact action causes elements 100 and 102 to form a bond via bonding material 106. FIG. 2E is a top view of element 100 after receiving bonding material 106 dispensed in cavity 104.

As stated above, cavity 104 is of sufficient size and shape so as to have a volume greater than the volume of bonding material 106 forming the bond, thus ensuring that when elements 100, 102 are mated together, the bonding material, which can flow prior to solidifying into a bond, will flow into the cavity and will not impede the separation of elements 100, and 102.

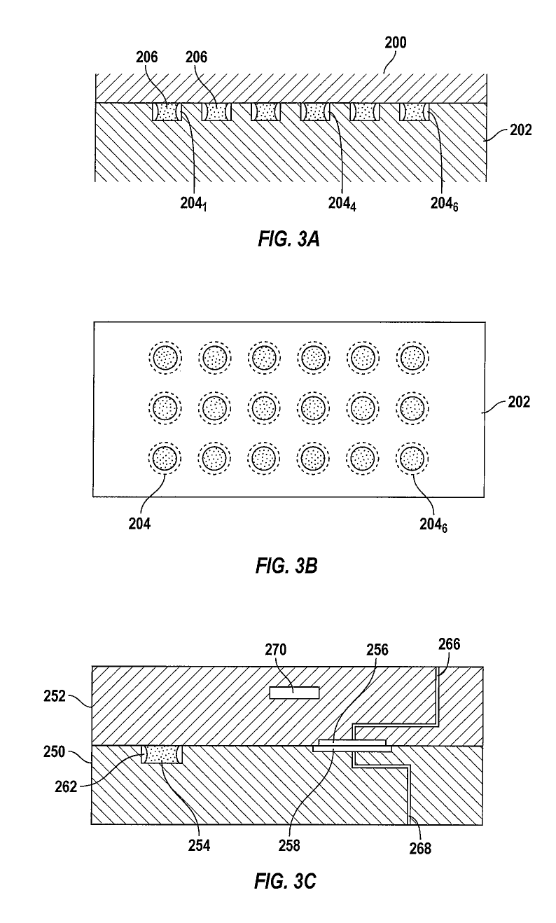

FIG. 3A is a cross-sectional view of elements 200 and 202 bonded via a multitude of cavities 204, in accordance with another embodiment the present invention. These cavities are formed in element 202 and subsequently receive suitable amounts of bonding material 206, in the same manner as described above respect to FIGS. 2A-2E. Thereafter, elements 200 and 202 are brought into contact so as to enable the bonding action to take place, as described above. FIG. 3B is a top view of element 202 having an exemplary 18 cavities arranged in 3 rows and 6 columns.

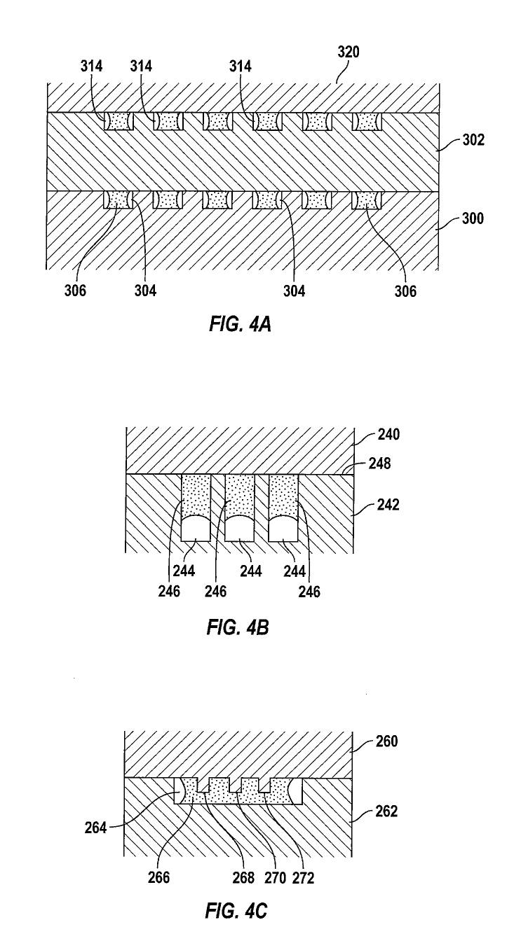

FIG. 4A is a cross-sectional view of a stack of elements 300, 302 and 320 bonded to one another, in accordance with another exemplary embodiment of the present invention. Elements 300 and 302 are shown as being bonded to one another via a first multitude of cavities 304, and elements 302 and 320 are shown as being bonded to one another via a second multitude of cavities 314.

Each cavity serves as a localized bond between the two bonded elements. As shown in FIGS. 3A, 3B and 4A, the cavities may be distributed over the surface of the parts so as to maximize the overall strength of the attachment. The cavities can be arrayed or distributed randomly.

Active devices may be interlaced with the cavities or they may be located in concentrated areas encompassed by the cavities. Furthermore, active devices on one element could be electrically interconnected to the other element where the interconnection takes place on the bonded surfaces. For example, referring to FIG. 3C, active device 270 may be electrically connected to conductive line 266 formed in element 252. By bonding element 252 and 250 via bonding material 254 inserted in trench 262, electrical connection is made between pads 256 and 258. Since pad 256 is in contact with metal line 266 and pad 258 is in contact with metal line 268, device 270 is also in electrical communication with metal line 268.

A variety of different cavity shapes, such as, rectangular, circular, or any other shape that can be injected or filled with bonding material may be used. In the embodiments shown in FIGS. 2A-2C (collectively referred to as FIG. 2), FIGS. 3A-3C (collectively referred to as FIG. 3), and FIG. 4A, the bonding material reach the bottom surfaces of their respective cavities, i.e., the bonding surfaces are parallel to the coplanar mating surfaces

FIG. 4B is a cross-sectional view of elements 240 and 242 bonded via a multitude of cavities 244, in accordance with another embodiment of the present invention. In the embodiment shown in FIG. 4B, the bonding materials 246 do not reach the bottom surfaces of their respective cavities, i.e., the bonding surfaces are perpendicular to the coplanar mating surface 248.

In yet other embodiments, one of the elements to be bonded includes one or more protrusions provided in the cavities in order to increase the surface area of the bonds. For example, as shown in FIG. 4C, element 260 is shown as including three protrusions 268, 270 and 272 that are provided in cavity 264 formed in element 262. These cavities increase the surface area to bond material 266.

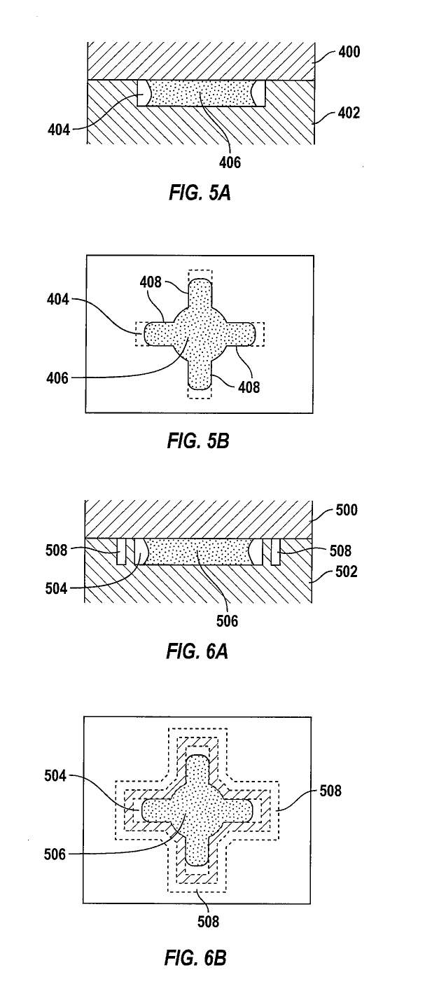

FIG. 5A is a cross-sectional view of elements 400 and 402 bonded via bonding material 406 dispensed in cavity 404 formed in element 402. FIG. 5B is a top view of cavity 404 and bonding material 406. Extensions 408 of cavity 404 accommodate overflow of bonding material 406.

FIG. 6A is a cross-sectional view of elements 500 and 502 bonded together, in accordance with the present invention. In addition to cavity 504, element 502 also includes wicking barriers 508. Wicking of bond material into the very small space separating the two elements can occur due to well-know capillary forces. Wicking barriers 508 break the surface tension of the material flow and thus prevent the flow of bonding material beyond the barrier.

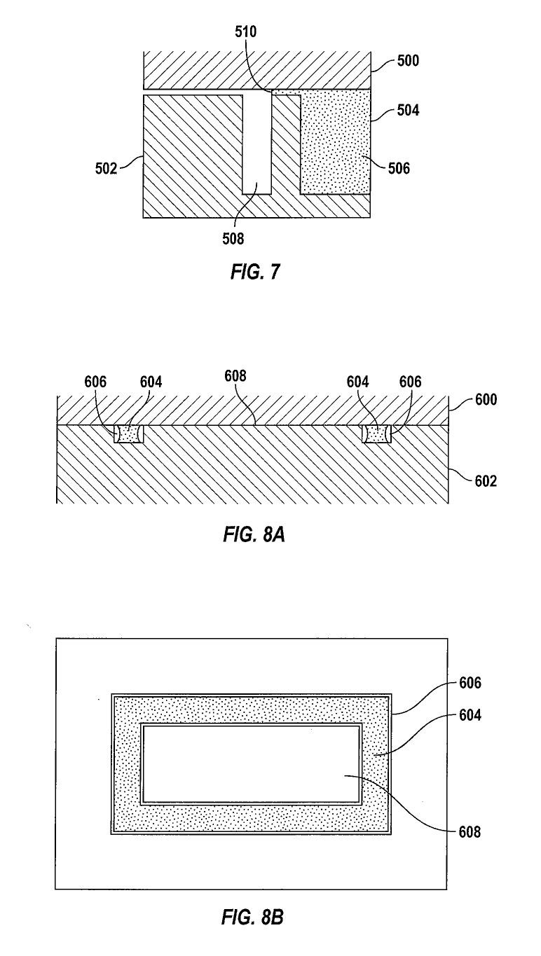

FIG. 7 is an enlarged view of cavity 504 and wicking barrier 508 shown in FIG. 6A. As is seen from this drawing, the bonding material 506 wicking out of cavity 504 is stopped at the edge of wicking barrier 508. FIG. 6B is a top view of element 504 showing the periphery of cavity 404, wicking barrier 508 and bonding material 506.

FIG. 8A is a cross sectional view of elements 600 and 602 bonded with bond material 604 inserted in cavity 606, in accordance with any of the embodiments described above. FIG. 8B is a top view of element 602. As is seen from FIG. 8B, bonding material 604 and cavity 606 surround the interior area 608 that includes one or more active devices (not shown). In other words, interior area 608 is completely sealed by the bond. Such embodiments may be for applications in which active devices formed in the interior region 608 need to be hermetically sealed or sealed in a vacuum. Because the bonds are continuous, a leak-tight seal is formed.

It is understood that the bonding material may be any type of adhesive or solder suitable for use with the bonded parts. Such materials can easily be introduced into the bonding cavities before the bonds are hardened. Furthermore, a variety of processes can be used to form the bonding cavities such as etching, electroplating, or injection molding to bond two or more devices in accordance with the present invention. For example, if one of the parts is a thin silicon wafer or chip, the cavities can be formed by a deep-reactive-ion-etching process. A photoresist or silicon dioxide layer can serve as a mask for the etching process. The cavities can be formed prior to or after the active devices are fabricated or they can be integrated into the device fabrication process.

After the cavities have been formed and the parts are ready for bonding, a controlled volume of bonding material is injected into the cavities. A needle dispense process or screen-print process can be used. The dispensing process must satisfy two important conditions: 1) the volume of the bonding material must be less than the volume of the cavity it is injected into, and 2) the bonding material must protrude from the one of the mating surfaces so that the bonding material makes contact to the mating part when they are mated as depicted in FIG. 2C.

After dispensing the bonding material, pressure is applied between the parts until the mating surfaces make contact. The bond material is allowed to cure either at room temperature or at elevated temperature, depending on the material requirements. After curing, the combined structure is either completed or is ready for another part to be bonded.

The above embodiments of the present invention are illustrative and not limiting. Various alternatives and equivalents are possible. The invention is not limited by the height, width or shape of the cavities. Nor is the invention to be limited by the number of such cavities. The invention is not limited by any particular processing steps used to form the cavities. The invention is not limited by the bonding material used. The present invention may be used in MEMS or any other microstructures or devices. Other additions, subtractions or modifications are obvious in view of the present disclosure and are intended to fall within the scope of the appended claims.

What is claimed is:

1. A microstructure comprising:
a first element; and
a second element bonded to the first element via a bonding material dispensed in a cavity formed in the second element, wherein said cavity has a volume greater than a volume of the bonding material dispensed in the cavity.

2. The microstructure of claim 1 wherein said cavity has a cylindrical shape.

3. The microstructure of claim 1 wherein said first element includes one or more protrusions adapted to be inserted into the cavity.

4. The microstructure of claim 1 wherein a mating surface of the first element is coplanar with a mating surface of the second element.

5. The microstructure of claim 1 wherein said first element includes one or more protrusions provided in the cavity.

6. The microstructure of claim 1 wherein said second element comprises a wicking barrier positioned near the cavity.

7. A microstructure comprising:
a first element; and
a second element bonded to the first element via a plurality of bonding materials each dispensed in a different one of a plurality of cavities formed in the second element, wherein each of said cavities has a volume greater than a volume of the bonding material dispensed in that cavity.

8. The microstructure of claim 7 wherein said plurality of cavities are arranged along row and columns.

9. The microstructure of claim 7 wherein said second element comprises a plurality of wicking barriers each associated with and positioned adjacent one of the cavities.

10. The microstructure of claim 7 wherein a mating surface of the first element is coplanar with a mating surface of the second element.

11. The microstructure of claim 7 wherein said first element includes one or more protrusions adapted to be inserted into at least one of the cavities of the second element.

12. A microstructure comprising:
a first element;
a second element bonded to the first element via a first plurality of bonding materials each dispensed in a different one of a first plurality of cavities formed on a first surface of the second element; and
a third element bonded to a second surface of the second element via a second plurality of bonding materials each dispensed in a different one of a second plurality of cavities formed on a first surface of the third element.

13. The microstructure of claim 12 wherein each of said first and second plurality of cavities has an arbitrary shape.

14. The microstructure of claim 12 wherein said second element comprises a first plurality of wicking barriers, each of the first plurality of wicking barriers associated with and positioned adjacent one of the first plurality of cavities, and wherein said third element comprises a second plurality of wicking barriers each of the second plurality of wicking barriers associated with and positioned adjacent one of the second plurality of cavities.

15. The microstructure of claim 12 wherein a mating surface of the first element is coplanar with a first surface of the second element, and wherein a mating surface of the third element is coplanar with a second surface of the second element.

16. The microstructure of claim 12 wherein said first element includes one or more protrusions adapted to be inserted into at least one of the cavities of the second element.

17. The microstructure of claim 16 wherein said second element includes one or more protrusions adapted to be inserted into at least one of the cavities of the third element.

18. A microstructure comprising:
a first element having a cavity formed therein and enclosing a region; and
a second element bonded to the first element via a bonding material inserted in the cavity.

19. The microstructure of claim 18 wherein said enclosed region comprises one or more active micro devices.

20. A method of forming a bond between first and second elements, the first and second elements being microstructure elements, the method comprising:
forming a cavity in the first element;
dispensing a bonding material in the cavity; and
forming a contact between the second element and the first element such that the bonding material is in direct contact with both the first and second elements, wherein said cavity has a volume greater than a volume of the bonding material dispensed in the cavity.

21. The method of claim 20 wherein said cavity has a cylindrical shape.

22. The method of claim 20 wherein said cavity has a volume greater than a volume of the bonding material dispensed therein.

23. The method of claim 20 further comprising:
forming a wicking barrier adjacent the cavity.

24. The method of claim 20 wherein a mating surface of the first element is coplanar with a mating surface of the second element.

25. The method of claim 20 wherein said first element includes one or more protrusions adapted to be inserted into the cavity.

26. A method of forming a bond between first and second elements, the first and second elements being microstructure elements, the method comprising:
forming a plurality of cavities in the first element;
dispensing a bonding material in each of the first plurality of cavities; and
forming a contact between the second element and the first element such that the bonding material in each cavity is in direct contact with both the first and second elements, wherein each of said plurality of cavities has a volume greater than a volume of the bonding material dispensed in that cavity.

27. The method of claim 26 wherein said plurality of cavities are arranged along row and columns.

28. The method of claim 26 further comprising:
forming a plurality of wicking barriers each associated with and positioned adjacent a different one of the plurality of cavities.

29. The method of claim 26 wherein a mating surface of the first element is coplanar with a mating surface of the second element.

30. The method of claim 26 wherein said first element includes one or more protrusions adapted to be inserted into the cavity.

31. A method of forming a bond between first, second and third elements, the method comprising:
forming one or more cavities in the first element;
dispensing a bonding material in each of the one or more cavities; and
forming a contact between the second element and the first element such that the bonding material in each of the one or more cavities is in direct contact with both the first and second elements;
forming one or more cavities in the third element;
dispensing a bonding material in each of the one or more cavities of the third element; and
forming a contact between the third element and the first element such that the bonding material in each of the one or more cavities of the third element is in direct contact with both the first and third elements.

32. The method of claim 31 wherein each of the cavities in the first or third element has an arbitrary shape.

33. The method of claim 31 further comprising:
forming a first one or more wicking barriers associated with and positioned adjacent one or more cavities of the first element; and
forming a second one or more wicking barriers associated with and positioned adjacent one or more cavities of the third element.

34. The method of claim 31 wherein a mating surface of the first element is coplanar with a first surface of the second element, and wherein a mating surface of the third element is coplanar with a second surface of the second element.

35. The method of claim 31 wherein said first element includes one or more protrusions adapted to be inserted into at least one of the cavities of the second element.

36. The method of claim 31 wherein said second element includes one or more protrusions adapted to be inserted into at least one of the cavities of the third element.

37. A method of sealing an enclosed area, the method comprising:
forming a cavity along edges of a first element, said cavity defining the enclosed area to be sealed; and
bonding a second element to the first element via a bonding material inserted in the cavity.

38. The method of claim 37 further comprising:
forming one or more active micro devices in the enclosed area before the bonding.
